(19) United States
(12) Patent Application Publication
(10) Pub. No.: US 2024/0073857 A1
(43) Pub. Date: Feb. 29, 2024

(54) METHODS, COMMUNICATIONS DEVICE AND INFRASTRUCTURE EQUIPMENT FOR A NON-TERRESTRIAL NETWORK

(71) Applicant: Sony Group Corporation, Tokyo (JP)

(72) Inventors: Martin Warwick BEALE, Basingstoke (GB); Shin Horng WONG, Basingstoke (GB)

(73) Assignee: Sony Group Corporation, Tokyo (JP)

(21) Appl. No.: 18/270,863

(22) PCT Filed: Jan. 7, 2022
(86) PCT No.: PCT/EP2022/050243

§ 371 Date: Jul. 5, 2023

(30) Foreign Application Priority Data
Jan. 14, 2021 (EP) 21151670.3

(51) Int. Cl. H04W 64/00; H04B 7/185; H04W 72/1268

(52) U.S. Cl. CPC H04W 64/003; H04B 7/1855; H04W 72/1268

(57) ABSTRACT

A method of operating a communications device configured to transmit uplink signals to and/or to receive downlink signals from a non-terrestrial infrastructure equipment forming part of a non-terrestrial network, NTN, the method comprising: determining to not transmit any uplink signal until at least a time after the communications device receives first motion information of the non-terrestrial infrastructure equipment; receiving, from the non-terrestrial infrastructure equipment, first motion information; based on information specific to the communications device and on determining that the communications device has received the first motion information, determining an uplink time to transmit an uplink signal; and transmitting the uplink signal at the uplink time.

The present application claims the Paris Convention priority of European patent application EP21151670.3, filed 14 Jan. 2021, the contents of which are hereby incorporated by reference.

### BACKGROUND

### Field

The present disclosure relates generally to communications devices, infrastructure equipment and methods of operating communications devices and infrastructure equipment, and specifically to providing information regarding non-terrestrial infrastructure of a non-Terrestrial Network, NTN, to a communications device.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the third generation partnership project (3GPP) defined UMTS and Long Term Evolution (LTE) architectures, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example it is expected that future wireless communications networks will efficiently support communications with devices including reduced complexity devices, machine type communication (MTC) devices, high resolution video displays, virtual reality headsets and so on. Some of these different types of devices may be deployed in very large numbers, for example low complexity devices for supporting the “Internet of Things”, and may typically be associated with the transmission of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles. There is similarly expected to be a desire for such connectivity to be available over a wide geographic area.

One example area of current interest in this regard includes so-called “non-terrestrial networks”, or NTN for short. The 3GPP has proposed in Release 15 of the 3GPP specifications to develop technologies for providing coverage by means of one or more antennas mounted on an airborne or space-borne vehicle [1].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY

Aspects of the invention are defined in the appended claims.

In a first aspect there is provided a method of operating a communications device configured to transmit uplink signals to and/or to receive downlink signals from a non-terrestrial infrastructure equipment forming part of a non-terrestrial network, NTN, the method comprising: determining to not transmit any uplink signal until at least a time after the communications device receives first motion information of the non-terrestrial infrastructure equipment; receiving, from the non-terrestrial infrastructure equipment, first motion information; based on information specific to the communications device and on determining that the communications device has received the first motion information, determining an uplink time to transmit an uplink signal; and transmitting the uplink signal at the uplink time. In a second aspect there is provided a method of operating a communications device configured to transmit uplink signals to and/or to receive downlink signals from a non-terrestrial infrastructure equipment forming part of a non-terrestrial network, NTN, the method comprising: determining to not transmit any uplink signal until at least a time after the communications device receives first motion information of the non-terrestrial infrastructure equipment; preparing a first uplink signal for transmission to the NTN; determining that the communications device has already received the first motion information; based on determining that the communications device has already received the first motion information, transmitting a first uplink signal at a first time.

In a third aspect there is provided a method of operating infrastructure equipment forming part of a non-terrestrial network, NTN, the method comprising: broadcasting first signalling information for receipt by the plurality of communications devices, wherein the first signalling information comprises first motion information, and wherein the plurality of communications devices are configured to determine respective uplink times to transmit an uplink signal based on information specific to the respective communications device; receiving, from a first communications device of the plurality of communications devices, a first uplink signal at a first uplink time; and receiving, from a second communications device of the plurality of communications devices, a second uplink signal at a second uplink time different than the first uplink time.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 is reproduced from [1], and illustrates a first example of a non-terrestrial network (NTN) featuring an access networking service relay node and based on a satellite/aerial with a bent pipe payload;

FIG. 5 is reproduced from [1], and illustrates a second example of an NTN featuring an access networking service relay node and based on a satellite/aerial connected to a gNodeB;

FIG. 6 schematically shows an example of a wireless communications system comprising an NTN part and a terrestrial network (TN) part which may be configured to operate in accordance with embodiments of the present disclosure;

FIG. 7 illustrates how network congestion can arise from delaying uplink transmissions.

FIG. 8 illustrates an example arrangement for delaying uplink transmissions by an amount that is based on an identifier of a communications device.

FIG. 9 illustrates an example arrangement for delaying uplink transmissions by an amount that is based on a random number generated at a communications device.

FIG. 10 illustrates an example arrangement for signalling a set of communications devices that are permitted to access a network at a particular time.

FIG. 11 illustrates an example arrangement for signalling a set of communications devices that are permitted to access a network at a particular time in a manner that reduces power consumption.

FIG. 12 illustrates an example arrangement for signalling a set of communications devices that are permitted to access a network at a particular time that is adaptable based on network congestion.

FIG. 13 illustrates a flow diagram for a method of operating a communications device.

FIG. 14 illustrates a flow diagram for a method of operating infrastructure equipment of an NTN.

FIG. 15 illustrates a flow diagram for a method of operating a communications device.

### DETAILED DESCRIPTION OF THE EMBODIMENTS

Long Term Evolution Advanced Radio Access Technology (4G)

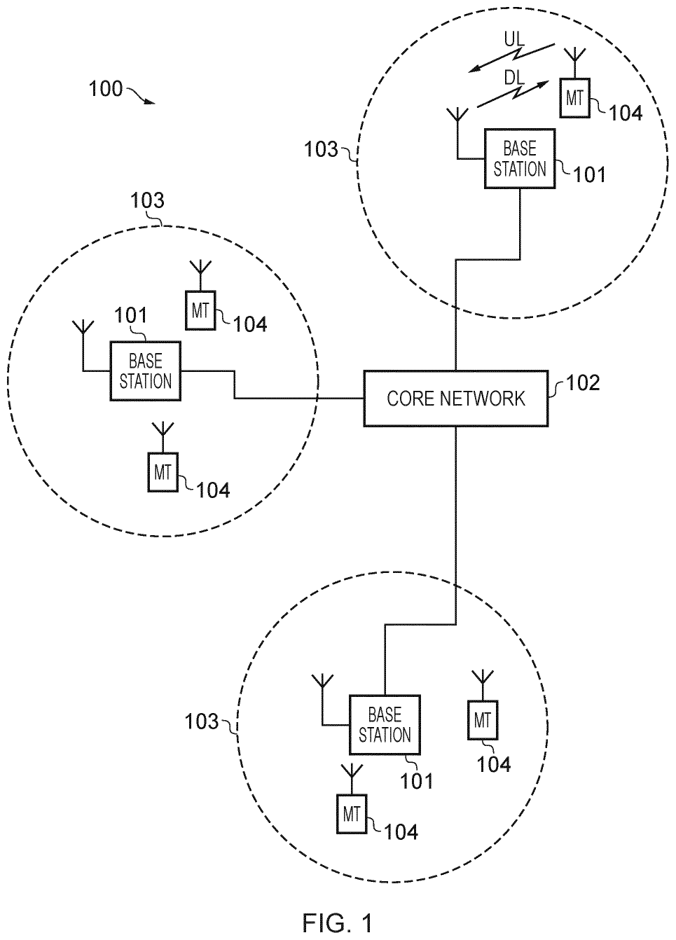

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A pi. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

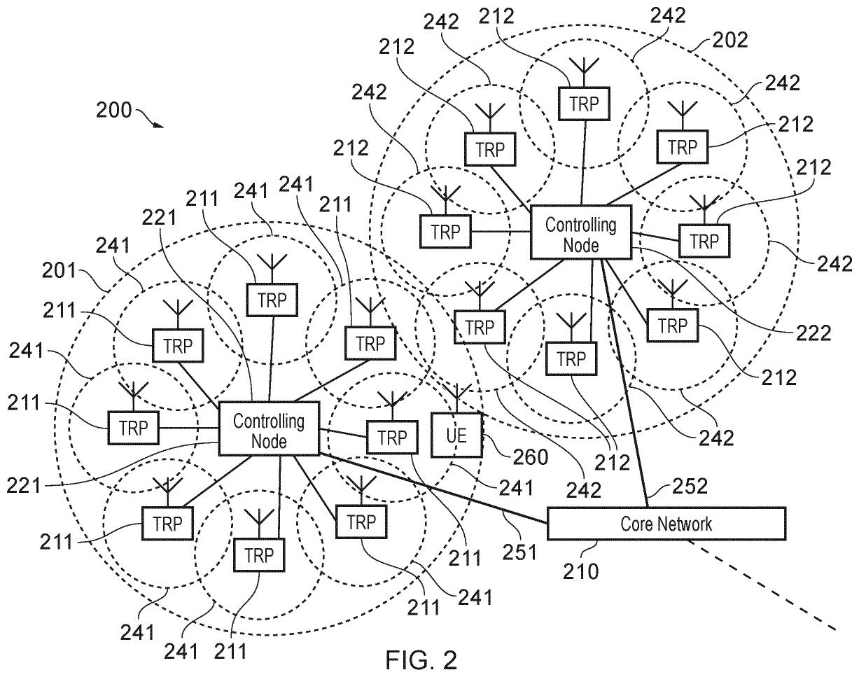

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

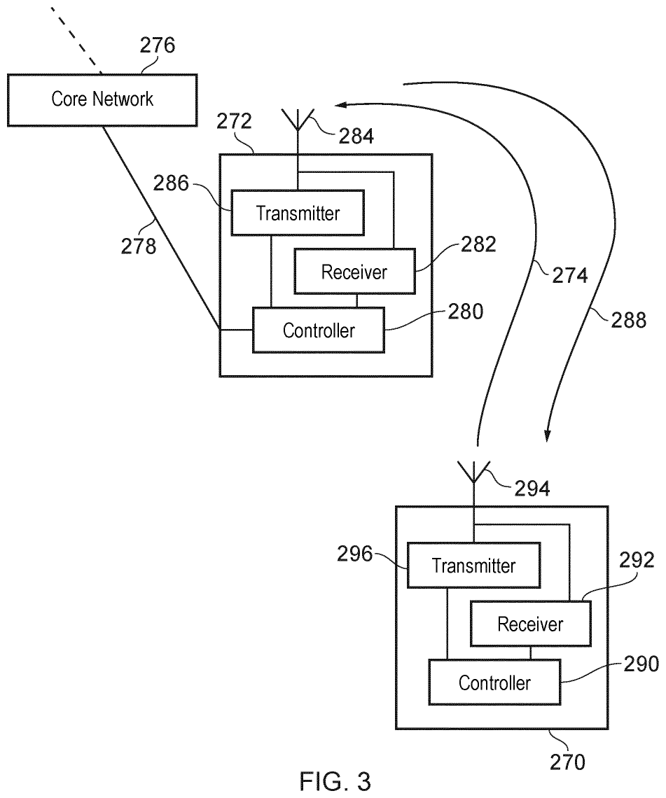

A more detailed illustration of a communications device 270 and an example network infrastructure equipment 272, which may be thought of as a eNB or a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

Non-Terrestrial Networks (NTNs)

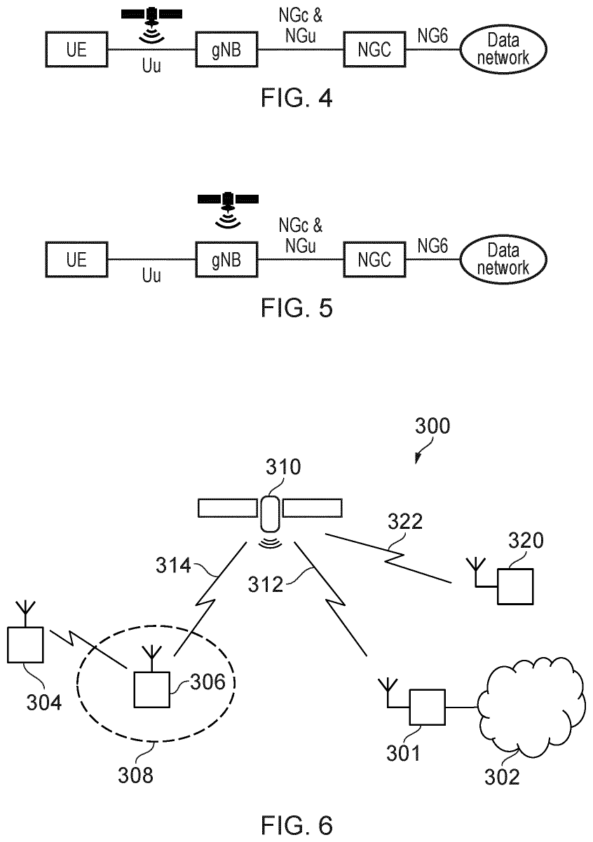

An overview of NR-NTN can be found in Pi, and much of the following wording, along with FIGS. 4 and 5, has been reproduced from that document as a way of background.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G network (isolated/remote areas, on board aircrafts or vessels) and underserved areas (e.g. sub-urban/rural areas) to upgrade the performance of limited terrestrial networks in cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

FIG. 4 illustrates a first example of an NTN architecture based on a satellite/aerial platform (which may be referred to as non-terrestrial infrastructure equipment) with a bent pipe payload, meaning that the same data is sent back down to Earth as is received by the satellite/aerial platform, with only frequency or amplification changing; i.e. acting like a pipe with a u-bend. In this example NTN, the satellite or the aerial platform will therefore relay a NR (or LTE) signal between the gNodeB (or eNodeB) and UEs in a transparent manner. Hereinafter,

FIG. 5 illustrates a second example of an NTN architecture based on a satellite/aerial platform (which may also be referred to as non-terrestrial infrastructure equipment) comprising a gNodeB (or eNodeB in the examples of this disclosure). In this example NTN, the satellite or aerial platform carries a full or part of a gNodeB to generate or receive a NR signal to/from the UEs. For example, in addition to frequency conversion and amplification, the satellite/aerial platform may also decode a received signal. This requires the satellite or aerial platform sufficient on-board processing capabilities to be able to include a gNodeB or eNodeB functionality.

FIG. 6 schematically shows an example of a wireless communications system 300 which may be configured to operate in accordance with embodiments of the present disclosure. The wireless communications system 300 in this example is based broadly around an LTE-type or 5G-type architecture. Many aspects of the operation of the wireless communications system/network 300 are known and understood and are not described here in detail in the interest of brevity. Operational aspects of the wireless communications system 300 which are not specifically described herein may be implemented in accordance with any known techniques, for example according to the current LTE-standards or the proposed 5G standards.

The wireless communications system 300 comprises a core network part 302 (which may be a 4G core network or a 5G core network) in communicative connection with a radio network part. The radio network part comprises a terrestrial station 301 connected to a non-terrestrial network part 310. The non-terrestrial network part 310 may be an example of infrastructure equipment. Alternatively, or in addition, the non-terrestrial network part 310 may be mounted on a satellite vehicle or on an airborne vehicle. In some cases, the base station (e.g. g-Node B/e-node B) may be fully implemented in the terrestrial station 301 or in the non-terrestrial network part 310, or may partially implemented in one or both of the terrestrial station 301 or in the non-terrestrial network part 310.

The non-terrestrial network part 310 may communicate with a communications device 306, located within a cell 308, by means of a wireless access interface provided by a wireless communications link 314. For example, the cell 308 may correspond to the coverage area of a spot beam generated by the non-terrestrial network part 310. The boundary of the cell 308 may depend on an altitude of the non-terrestrial network part 310 and a configuration of one or more antennas of the non-terrestrial network part 310 by which the non-terrestrial network part 310 transmits and receives signals on the wireless access interface.

The non-terrestrial network part 310 may be a satellite in an orbit with respect to the Earth, or may be mounted on such a satellite. For example, the satellite may be in a geo-stationary earth orbit (GEO) such that the non-terrestrial network part 310 does not move with respect to a fixed point on the Earth's surface. The geo-stationary earth orbit may be approximately 36,786 km above the Earth's equator. The satellite may alternatively be in a low-earth orbit (LEO), in which the non-terrestrial network part 310 may complete an orbit of the Earth relatively quickly, thus providing moving cell coverage. Alternatively, the satellite may be in a non-geostationary orbit (NGSO), so that the non-terrestrial network part 310 moves with respect to a fixed point on the Earth's surface. The non-terrestrial network part 310 may be an airborne vehicle such as an aircraft, or may be mounted on such a vehicle. The airborne vehicle (and hence the non-terrestrial network part 310) may be stationary with respect to the surface of the Earth or may move with respect to the surface of the Earth.

In FIG. 6, the terrestrial station 301 is shown as ground-based, and connected to the non-terrestrial network part 310 by means of a wireless communications link 312. The non-terrestrial network part 310 receives signals representing downlink data transmitted by the base station 301 on the wireless communications link 312 and, based on the received signals, transmits signals representing the downlink data via the wireless communications link 314 providing the wireless access interface for the communications device 306. Similarly, the non-terrestrial network part 310 receives signals representing uplink data transmitted by the communications device 306 via the wireless access interface comprising the wireless communications link 314 and transmits signals representing the uplink data to the terrestrial station 301 on the wireless communications link 312. The wireless communications links 312, 314 may operate at a same frequency, or may operate at different frequencies

The extent to which the non-terrestrial network part 310 processes the received signals may depend upon a processing capability of the non-terrestrial network part 310. For example, the non-terrestrial network part 310 may receive signals representing the downlink data on the wireless communication link 312, amplify them and (if needed) re-modulate onto an appropriate carrier frequency for onwards transmission on the wireless access interface provided by the wireless communications link 314. Alternatively, the non-terrestrial network part 310 may be configured to decode the signals representing the downlink data received on the wireless communication link 312 into un-encoded downlink data, re-encode the downlink data and modulate the encoded downlink data onto the appropriate carrier frequency for onwards transmission on the wireless access interface provided by the wireless communications link 314.

The non-terrestrial network part 310 may be configured to perform some of the functionality conventionally carried out by a base station (e.g. a gNodeB or an eNodeB), such as base station 101 of FIG. 1. In particular, latency-sensitive functionality (such as acknowledging a receipt of the uplink data, or responding to a RACH request) may be performed by the non-terrestrial network part 310 partially implementing some of the functions of a base station.

As mentioned above, a base station may be co-located with the non-terrestrial network part 310; for example, both may be mounted on the same satellite vehicle or airborne vehicle, and there may be a physical (e.g. wired, or fibre optic) connection on board the satellite vehicle or airborne vehicle, providing the coupling between the terrestrial station 301 and the non-terrestrial network part 310. In such co-located arrangements, a wireless communications feeder link between the terrestrial station 301 and a terrestrial station (not shown) may provide connectivity between the base station (co-located with the non-terrestrial part 310) and the core network part 302.

The terrestrial station 301 may be a NTN Gateway that is configured to transmit signals to the terrestrial network part 310 via the wireless communications link 312 and to communicate with the core network part 302. That is, in some examples the terrestrial station 301 may not include base station functionality. For example, if the base station is co-located with the non-terrestrial network part 310, as described above, the terrestrial station 301 does not implement base station functionality. In other examples, the base station may be co-located with the NTN Gateway in the terrestrial station 301, such that the terrestrial station 301 is capable of performing base station (e.g. gNode B or eNodeB) functionality.

In some examples, even if the base station is not co-located with the non-terrestrial network part 310 (such that the base station functionality is implemented by a ground-based component), the terrestrial station 301 may not necessarily implement the base station functionality. In other words, the base station (e.g. gNodeB or eNodeB) may not be co-located with the terrestrial station 301 (NTN Gateway). In this manner, the terrestrial station 301 (NTN Gateway) transmits signals received from the non-terrestrial network part 310 to a base station (not shown in FIG. 6). In such an example, the base station (e.g. gNodeB or eNodeB) may be considered as being part of core network part 302, or may be separate (not shown in FIG. 6) from the core network part 302 and located logically between the terrestrial station 301 (NTN Gateway) and the core network part 302.

In some cases, the communications device 306 shown in FIG. 6 may be configured to act as a relay node. That is, it may provide connectivity to one or more terminal devices such as the terminal device 304. When acting as a relay node, the communications device 306 transmits and receives data to and from the terminal device 304, and relays it, via the non-terrestrial network part 310 to the terrestrial station 301. The communications device 306, acting as a relay node, may thus provide connectivity to the core network part 302 for terminal devices which are within a transmission range of the communications device 306.

In some cases, the non-terrestrial network part 310 is also connected to a ground station 320 via a wireless link 322. The ground station may for example be operated by the satellite operator (which may be the same as the mobile operator for the core and/or radio network or may be a different operator) and the link 322 may be used as a management link and/or to exchange control information. In some cases, once the non-terrestrial network part 310 has identified its current position and velocity, it can send position and velocity information to the ground station 320. The position and velocity information may be shared as appropriate, e.g. with one or more of the UE 306, terrestrial station 301 and base station, for configuring the wireless communication accordingly (e.g. via links 312 and/or 314).

It will be apparent to those skilled in the art that many scenarios can be envisaged in which the combination of the communications device 306 and the non-terrestrial network part 310 can provide enhanced service to end users. For example, the communications device 306 may be mounted on a passenger vehicle such as a bus or train which travels through rural areas where coverage by terrestrial base stations may be limited. Terminal devices on the vehicle may obtain service via the communications device 306 acting as a relay, which communicates with the non-terrestrial network part 310.

A challenge of conventional techniques may be the relatively high rate at which cell changes occur for the communications device 306 obtaining service from one or more non-terrestrial network parts. For example, where the non-terrestrial network part 310 is mounted on a satellite in a low-earth orbit (LEO), the non-terrestrial network part 310 may complete an orbit of the Earth in around 90 minutes; the coverage of a cell generated by the non-terrestrial network part 310 will move very rapidly, with respect to a fixed observation point on the surface of the Earth. Similarly, it may be expected that the communications device 306 may be mounted on an airborne vehicle itself, having a ground speed of several hundreds of kilometres per hour.

Satellite Positional Information

One particular difficulty associated with LEO NTNs is the large distances and relative speeds between the UE and the non-terrestrial network part (e.g. satellite or aerial platform). For example, if a non-terrestrial network part is mounted on a satellite in LEO, the distance between the non-terrestrial network part and the UE may be between 600 km to 1200 km. Hence, the propagation delay between the UE (hereinafter the term UE is used to refer to any communications device configured to communicate with a non-terrestrial part of an NTN) and the eNB (or gNB or NTN Gateway) is significantly larger than for terrestrial networks, particularly in a ‘transparent’ arrangement such as that shown in FIG. 4. For example, for an NTN using a transparent LEO satellite, the Round Trip Time (RTT) between the UE and the eNB/gNB/NTN Gateway may be between approximately 8 ms to approximately 26 ms. Furthermore, the distance between the non-terrestrial network part and the UE continually changes.

In order to take into account this large propagation delay, uplink transmissions would need to apply a large Timing Advance (TA) and the eNB/gNB/NTN Gateway would need to take into account of this for scheduling of uplink data. The timing advance that needs to be applied depends on the location of the UE within the cell footprint of the satellite. Since the cell footprint can be large, there can be a large variation of the timing advance that needs to be applied, depending on the UE location within the cell footprint.

In addition to the increased RTT between the UE and the gNB/eNB/NTN Gateway, the NTN system also needs to take into account the movement of the satellite. For example, a LEO satellite can be travelling at 7.56 km/second (27,216 km/h) relative to the UE, which would cause significant Doppler shift that the UE needs to compensate for. In order to factor in the Doppler shift, i.e. pre-compensation for the frequency of the uplink transmissions, the UE needs to know its own geo-location and the motion (e.g. position and velocity) of the satellite. The geo-location of the UE can, for example, be obtained from Global Navigation Satellite System (GNSS) or from any other suitable means.

The position and velocity of the satellite can be derived from the satellite ephemeris information, that is the satellite orbital trajectory, which can be periodically broadcast to the UE, e.g. via Signaling Information Blocks (SIBs). However, broadcasting ephemeris information, e.g. every 100 ms, can lead to high signaling overhead.

Furthermore, signaling ephemeris information does not take into account perturbations in the satellite orbit and hence may not provide sufficient accuracy to determine the required timing advance and frequency compensation. In particular, satellites in LEO do not exist in a perfect vacuum and thus experience a number of factors such as varying drag coefficients or gravitational forces which perturb the orbit of the satellite. As such, as the time since a UE last received a periodic broadcast of the satellite ephemeris information increases, the accuracy with which the UE can accurately determine the position and velocity of the satellite decreases.

One possibility is that instead of sending ephemeris information, the gNB/eNB/NTN Gateway can derive the satellite position and velocity and broadcast it via the SIBs. The satellite position and velocity may be determined by the gNB/eNB/NTN Gateway, for example, via GNSS or other suitable means. The gNB/eNB/NTN Gateway may determine the satellite position and velocity via communications on the network itself, or the gNB/eNB/NTN Gateway may determine the satellite position and velocity by other means, separate from the network. For example, the gNB/eNB/NTN Gateway may derive the satellite position and velocity, e.g. via a telemetry link to the satellite, and it may signal that information to the gNB/eNB/NTN Gateway which may then transmit the SIBs. The gNB/eNB/NTN Gateway may estimate satellite position and velocity at the System Number (SFN) in which the SIB is broadcasted, thereby providing real time position and velocity information. Hereinafter, the term ‘gNB’ is used to refer to any of a base station, a gNB, an eNB or an NTN gateway, unless explicitly stated otherwise.

SIBs are broadcasted periodically and consequently the gNB is not aware of when a UE last read a SIB broadcast, as a UE may not necessarily read each and every SIB broadcast. As such, the UE may not have up to date information at the point where an uplink transmission is scheduled for a UE. Therefore, the UE may not be able to accurately compensate for the Doppler shift between the UE and the satellite. Furthermore, for half-duplex frequency division multiplex (HF_FDD) UEs, the gNB may not be able to schedule any uplink transmissions that may collide with the SIB transmission that carries the satellite information in the downlink. As such, the scheduling for such a UE may be restricted.

In some approaches, UEs may be instructed to not transmit uplink transmissions until after the UEs have received up to date satellite motion information. In this manner, the uplink transmission is delayed until after the UEs receive a subsequent SIB broadcast including the satellite motion information. The subsequent SIB broadcast including the satellite motion information may be received by a large number of devices. Therefore, after the SIB is broadcast, a large number of devices may attempt to begin an uplink transmission at substantially the same time. This may cause network congestion and may in some cases lead to information loss.

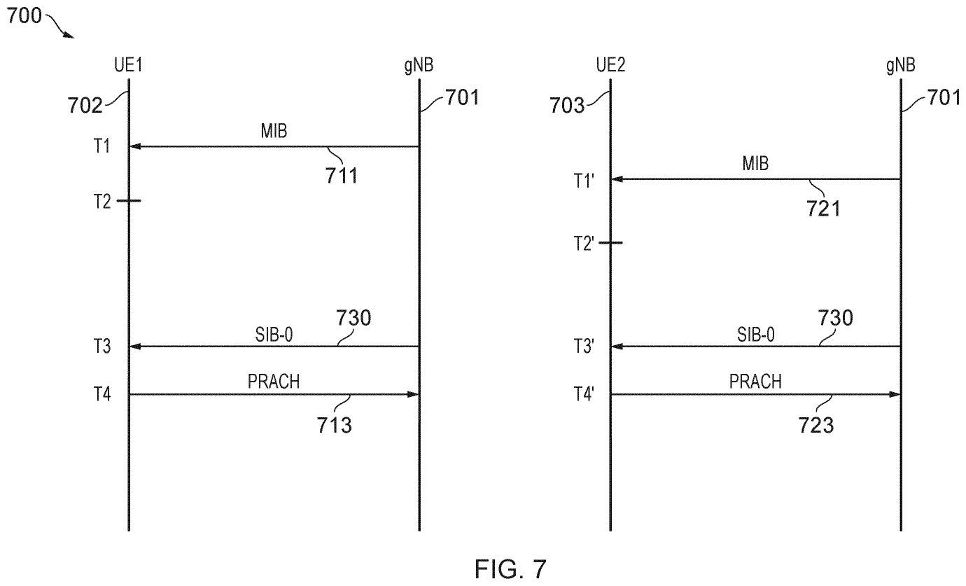

FIG. 7 shows an example arrangement where UEs 702, 703 configured to delay transmission of an uplink signal until after the UEs have received up to date satellite motion information via an SIB. In this example and subsequent examples of this disclosure, UEs are described as being instructed to delay transmission of an uplink signal until after the UEs have received up to date satellite motion information via an SIB, however it should be appreciated that in all of the examples of this disclosure, a UE may not necessarily receive an explicit instruction to delay an uplink transmission, but may rather make its own determination to delay an uplink transmission. For example, such a determination may be made based on an internal configuration and/or a time at which the UE last received satellite motion information. In the arrangement of FIG. 7, the satellite motion information is broadcast via SIB-0 730 (note that no technical significance should be attributed to the label ‘SIB-0’ which is used to distinguish the SIB broadcast containing satellite motion information from other SIB broadcasts) and is received by UE1 702 and UE2 703, although SIB-0 730 may be received by many more UEs.

At time T1, UE1 702 receives signalling information via a master information block (MIB) 711. MIB 711 may contain, for example, synchronisation information useable by UE1 702 or may contain other signalling information. MIB 711 may be broadcast for receipt by a number of UEs, for example on a physical broadcast channel (PBCH). MIB 711 may be broadcast periodically, for example, every 40 ms, although other time periods may be utilised in some examples. MIB 711 may be a single broadcast, as shown in FIG. 7, or may include multiple broadcasts, each transmitting a portion of the total information included in MIB 711. For example, MIB 711 may include four transmissions, transmitted 10 ms apart, such that the total MIB 711 is transmitted every 40 ms. At time T1′, UE2 703 receives MIB 712, which may be the same MIB as MIB 711, or MIB 721 may be a different MIB that is broadcast at a different time to MIB 711 such that times T1 and T1′ are different to one another. If MIB 711 and MIB 721 are the same MIB, times T1 and T1′ may be substantially equal to one another (although in practice times T1 and T1′ will not be exactly equal to one another due to factors such as propagation delay).

MIB 711 and MIB 721 may, in some examples, also include instructions that instruct UE1 702 and UE1 703 not to transmit any uplink signals until after they received up to date satellite motion information, however as described above, the UEs 702,703 may make a determination not to transmit any uplink signals until after they received up to date satellite motion information without such instructions. In the following discussion the terms uplink signal and uplink transmission are used interchangeably. After receiving MIB 711, UE1 702 processes the contents of MIB 711 and at time T2 prepares an uplink signal for transmission. Time T2 may, for example, be the time at which the contents of the uplink signal are stored in a buffer of UE1 702 in preparation for transmission. However, as UE1 702 has made a determination not to transmit any uplink signals until after UE1 702 has received up to date satellite motion information, UE1 702 does not transmit the uplink signal at time T2. The uplink signal may, for example, be an uplink on a physical random access channel (PRACH). UE2 703 also does not transmit an uplink signal at time T2′, when it has prepared an uplink signal, for the same reasons.

The UEs 702, 703 then receive SIB-0 at times T3 and T3′ respectively. As both UE1 702 and UE2 703 receive the same SIB-0 broadcast, times T3 and T3′ are substantially equal to one another (although in practice times T3 and T3′ will not be exactly equal to one another due to factors such as propagation delay). Both UEs 702, 703 then proceed to process and store the satellite motion information.

As both UEs 702, 703 now possess up to date satellite motion information, both UEs begin transmitting the PRACH 713, 723 uplink signals prepared at times T2 and T2′, and these are transmitted at times T4 and T4′ respectively. As UE1 702 and UE2 703 receive SIB-0 at substantially the same time, both UEs 702, 703 process and store the satellite motion information at substantially the same time. Therefore, times T4 and T4′ are substantially equal to one another (although in practice times T4 and T4′ will not be exactly equal to one another due to factors such as propagation delay and processing speed).

Therefore, UEs 702, 703 transmit their respective PRACHs 713, 723 at substantially the same time, which may lead to PRACH collision. Furthermore, if more UEs receive SIB-0, the transmission of a large number of uplink transmissions from different UEs can cause network congestion, leading to performance degradation.

The example of FIG. 7 is described with signalling information being transmitted on MIBs, however in practice, the signalling information may instead be transmitted on a SIB broadcast. Furthermore, the signalling information may be transmitted to specific UE devices (i.e. the signalling information is not broadcast) and the signalling information may be transmitted via substantially any transmission means, such as a UL Grant DCI message, a PDSCH or other transmission means. Moreover, in some examples, such signalling information may not be required to be transmitted to a UE in order for a particular uplink signal to be transmitted by a UE and as such the aforementioned challenges described with regards to FIG. 7 are equally applicable to examples not including such signalling information. Furthermore, while the uplink transmissions in the example of FIG. 7 is a PRACH, the uplink transmission may be any other suitable transmission, such as a PUSCH or a PUCCH. In addition, UE1 702 and UE3 703 need not receive the signalling information via the same means, and UE1 702 and UE3 703 need not transmit the same type of uplink signal.

The present disclosure provides means for delaying UE uplink transmissions until after up to date satellite motion information has been received, without causing network congestion, or uplink collision. To achieve this, uplink signals by UEs are delayed until a time after the UE has received up to date satellite motion information by an amount that is specific to the UE. Therefore, uplink transmissions by UEs that receive satellite motion information via a SIB are spread over a longer time period, reducing network congestion and avoiding uplink collision.

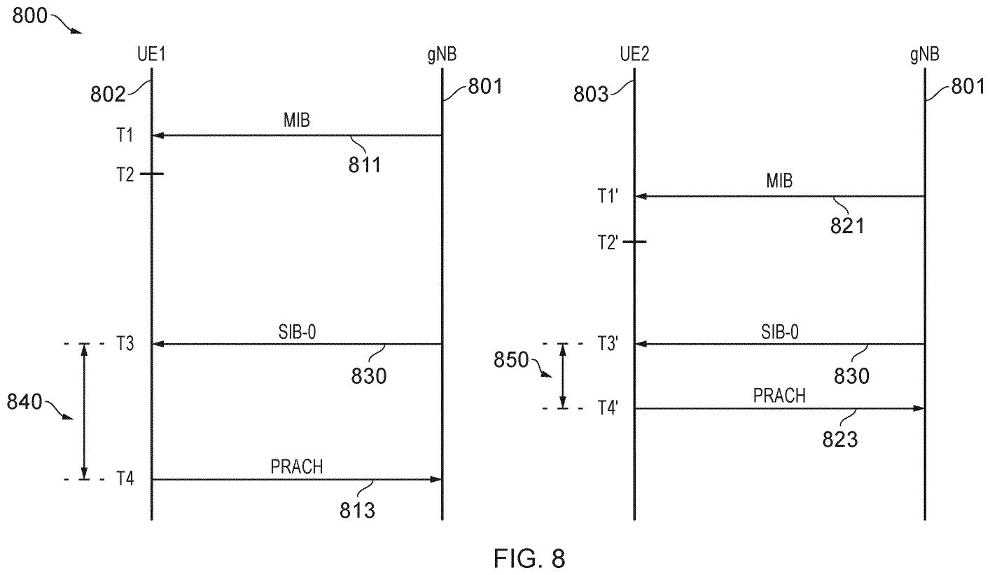

FIG. 8 shows an example arrangement 800 where uplink signals are delayed based on information specific to a UE. In the example of FIG. 8, UE1 802 receives signalling information via MIB 811 from gNB 801 at time T1. In some examples, UEs may receive the signalling information via different means, such as via an SIB or via a dedicated transmission. MIB 811 may in some examples, include instructions that instruct UE1 802 not to transmit any uplink signals until after UE1 802 has received (or stored) up to date satellite motion information. Alternatively, UE1 802 may itself determine not to transmit any uplink signals until after UE1 802 has received (or stored) up to date satellite motion information, independent of signalling information received. That is, UE1 802 may make such a determination based on an internal configuration and/or a time at which the UE last received satellite motion information. Furthermore, in such examples, UE1 802 is not required to receive signalling information in order to transmit a particular uplink signal (at a later point in time).

At time T2, UE1 prepares an uplink signal for transmission (for example in response to MIB 811). Time T2 may, for example, be the time at which the contents of the uplink signal are stored in a buffer of UE1 802 in preparation for transmission. Alternatively, T2 may not be the time at which UE1 prepares the uplink signal, but may instead be the time at which UE2 processes MIB 811. UE2 receives signalling information at time T1′ via MIB 821 and may prepare an uplink transmission at time T2′ in a manner similar to UE1.

UE1 802 and UE2 803 receive satellite motion information via SIB-0 830 (note that no technical significance should be attributed to the label ‘SIB-0’ which is used to distinguish the SIB broadcast containing satellite motion information from other SIB broadcasts). The UEs 802, 803 may in some cases store the satellite motion information, for example, in long term storage (such as a solid state drive or hard disk drive), or in short term storage, such as a cache or buffer. SIB-0 830 is received by UE1 802 and UE2 803 at times T3 and T3′ respectively, where times T3 and T3′ are substantially equal (although in practice times T3 and T3′ will not be exactly equal to one another due to factors such as propagation delay). T3 may in some cases represent the time at which SIB-0 is broadcast, in which case T3 is equal to T3′. SIB-0 may, in some examples, be an SIB dedicated to broadcasting satellite motion information. That is, SIB-0 830 may be separate from MIB broadcasts and other SIB broadcasts that provide signalling information to UEs. As such, SIB-0 830 may be broadcast with longer periodicity than MIB broadcasts or other SIB broadcasts, as satellite motion information may require updating less frequently. As such, by broadcasting satellite motion information less frequently, network capacity is preserved.

SIB-0 830 may, for example, be broadcast with a periodicity of 320 ms, however other periodicities may be utilised. For example, SIB-0 830 may be broadcast with a periodicity of between 100 ms and 5 s. Furthermore, a lowest periodicity value for SIB-0 830 may be an intermediate value such as 150 ms, 200 ms, 250 ms, 300 ms, 350 ms, 400 ms, 450 ms, and 500 ms, such that the range of possible periodicities for SIB-0 830 may in some cases be regarded as extending from any of these values to an upper value. A largest periodicity value for SIB-0 830 may also be any number of intermediate values such as 500 ms, 600 ms, 700 ms, 800 ms, 900 ms, 1 s, 1.5 s, 2 s, 3 s, or 4 s, such that the range of possible periodicities for SIB-0 830 may in some cases be regarded as extending from a lower value to any of these values. By way of comparison, MIB broadcasts may, for example, be broadcast with a periodicity of 40 ms, and other SIB broadcasts may be broadcast with a periodicity of, for example, 80 ms. As such, SIB-0 830 may be periodically broadcast with a time period that is longer than MIB broadcasts and other SIB broadcasts containing signalling information (such as an SIB1-BR broadcast or an SIB1-NB broadcast).

Before receiving SIB-0 830, UE1 802 determines that MIB 811 additionally includes an indication for UE1 802 to determine an uplink time for the uplink transmission, based on information specific to UE1 802. This indication may be an explicit instruction to calculate an uplink time based on particular information, or UE1 802 may itself identify that it is to determine an uplink time based on information specific to UE1 802 based on receipt of MIB 811 (such that MIB 811 does not include an instruction to do so). In other examples, UE1 802 may identify an uplink time independent of MIB 811 and/or independent of receipt of any signalling information. In other words, UE1 802 may make such a determination based on an internal configuration of UE1 802.

As one example, the uplink time may be based on a unique identifier of UE1 802. For instance, the unique identifier may be an international mobile subscriber identity (IMSI), an international mobile equipment identity (IMEI), or a packet temporary mobile subscriber identity (P-TMSI). In some examples, the unique identifier may be a radio network temporary identity (RNTI), where if a UE is in an idle mode (and thus may not be assigned a RNTI), the UE may use the RNTI it was assigned when it was last in a connected mode. Furthermore, multiple different identifier types may be used. For example, if a UE has not been assigned an RNTI, it may use its IMSI instead (in this case the UE may use a different equation to UEs using an RNTI). It should be appreciated that the list of identifier types above is not a closed list and that substantially any identifier that identifies a UE device may be used.

The UEs 802, 803 may then use the identifier (UE_ID) to determine an uplink transmission time T4. For example, UEs may use a modulo function to determine a time after receipt (or storage) of SIB-0 830 at which a UE should transmit its uplink signal prepared at time T2. The modulo function may, for example, be based on the UE_ID and the broadcast period for SIB-0, such that the uplink is calculated based on the function: UE_ID mod X, where X is the broadcast period for SIB-0 830. The result of this function may be used to identify a subframe after SIB-0 830 at which UE1 802 may transmit its uplink transmission. For example, if the period for SIB-0 830 is 320 ms, the subframe after SIB-0 830 at which a UE may transmit its uplink signal is UE_ID mod 320. As each UE will have a different UE_ID, a range of transmission times is possible (based on UE_IDs), thereby spreading out the transmission of uplink signals after SIB-0 830. For instance, in examples where the subframe after SIB-0 830 at which a UE may transmit its uplink signal is given by UE_ID mod 320, there are 320 possible values at which a given UE may transmit its uplink signal. For a given transmission, a UE will transmit at one of these 320 possible times based on its own value of UE_ID mod 320.

In some examples, the subframe after SIB-0 830 at which the UEs 802, 803 may transmit an uplink transmission may be calculated using the function: (UE_ID mod Y)*(X/Y), where X is the broadcast period for SIB-0 830, and Y=10 (the values of X and Y here are only example values and it should be appreciated that substantially any other value for X and Y could be used). For example, if Y=10, UE_ID mod Y produces the last digit of the UE_ID. Furthermore, X/Y splits the period between SIB-0 830 transmissions into Y equal parts. Accordingly, the time at which a UE transmits its uplink signal is determined based on the last digit of the UE_ID. As such, UEs with UE_ID that have the same final digit will transmit uplink signals at the same time, however the transmissions will be spread over 10 different time periods, each for UEs with a UE_ID with a different last digit.

The above calculation methods are only examples of calculation methods, and it should be appreciated that any other calculation method that allows uplink transmissions to be spread apart may be used. In some examples, an offset may be applied to the UE_ID in the above (or other) calculations in order to ensure that devices are not always assigned the same uplink transmission delay. The offset may, for example, be related to an SFN or a hyper SFN (H-SFN). The offset may, for example, be transmitted via an SIB broadcast, such as an SIB1-BR or SIB1-NB.

Additionally or alternatively to a UE_ID, the time at which a UE transmits its uplink signal may be based on an access class of the UE. For example, particular access classes may be assigned a higher priority than other access classes. As such, higher priority access classes may be permitted to transmit uplink signals earlier than lower priority access classes.

In some examples, the time at which a UE transmits its uplink signal may be based on a random number. For example, a UE may generate a random number at the time when an uplink transmission is stored in a buffer of the UE, or at any other time prior to or during receiving SIB-0 or after receiving the SIB-0, for example at a predetermined time after receiving SIB-0 or upon receiving and/or processing SIB-0. The UE may determine that it is to generate a random number (and determine the time to do so) independent of signalling information (for example based on an internal configuration of the UE). Alternatively, an MIB transmission or an SIB transmission may include instructions for a UE to generate a random number at a specified time. As an example, the generated random number may be between 0 and the period of SIB-0 (e.g. between 0 and 320), however a different time basis may be used. The UE may then transmit its uplink signal at the subframe corresponding to the generated random number. The time at which a UE can begin transmitting its uplink signal may be relative to the starting subframe at which the SIB-0 is transmitted, or relative to the subframe at which the SIB-0 is decoded.

Furthermore, in some examples, including in those above, an offset may be applied to the calculated time/subframe at which a UE is to begin an uplink transmission. For example, the earliest time after SIB-0 830 at which a UE may transmit its uplink signal may not be Oms, but may rather be a non-zero value. Accordingly, a UE may be provided with enough time to process the satellite motion information included in SIB-0 830 and calculate the necessary frequency pre-compensation and timing advance before its allocated uplink time. In addition, the latest time after SIB-0 830 at which a UE may transmit its uplink signal may not be the period of SIB-0, but may in fact be larger than the period of SIB-0. In this manner, a UE may transmit an uplink transmission at a time after a subsequent SIB-0 broadcast in which other UEs have not yet processed the satellite motion information included in the subsequent SIB-0 broadcast. In other words, the time after SIB-0 830 at which a UE may transmit an uplink signal may generally range from a lower value to an upper value.

Based on any of the above approaches, UE1 802 is able to calculate a time T4 at which UE1 802 transmits its uplink transmission 813 (a PRACH in the example of FIG. 8), which is delayed by a delay amount 840 from time T3 at which UE1 802 receives SIB-0 830. Similarly, UE2 803 is able to calculate a time T4′ at which UE2 803 transmits its uplink transmission 823 (a PRACH in the example of FIG. 8), which is delayed by a delay amount 850 from time T3′ at which UE2 803 receives SIB-0 830. Both UEs 802, 803 then proceed to transmit their uplink signals at times T4 and T4′ respectively, where the times T4 and T4′ are different from one another. As such, transmissions of uplink signals following SIB-0 830 can be more widely spread apart.

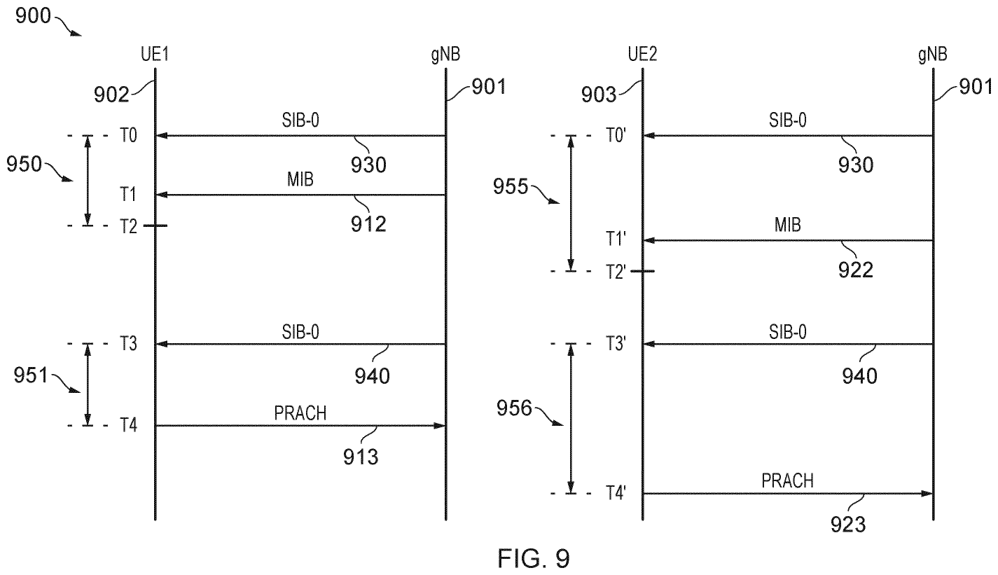

FIG. 9 shows an example arrangement 900 where two UEs 902, 903 determine uplink signal times T4 and T4′ for respective uplink signals 913, 923, based on the time T2 and T2′ at which the respective UE 902, 903 prepared the uplink signals 913, 923 for transmission. Times T2 and T2′ may, for example, be the time at which the contents of the uplink signal are stored in the buffers of UE1 902 and UE2 903 respectively, in preparation for transmission to a gNB 901. As shown, the UEs 902, 903 may receive signalling information, for example via MIBs 912 and 922, however the signalling information may take any other suitable form and the UEs 902, 903 may not necessarily receive signalling information in order to prepare the uplink signals 913, 923. Except where otherwise stated, the arrangement 900 of FIG. 9 is substantially similar to the arrangement 800 of FIG. 8 and the possible modifications described above in relation to the arrangement 800 of FIG. 8 may be considered equally applicable to the arrangement 900 of FIG. 9.

In the example of FIG. 9, the time T4 is determined based on the time difference 950 between time TO when the previous SIB-0 930 was broadcast and time T2. While in this example, the time TO refers to the time at which an SIB (in this case SIB-0 930) was broadcast, the time difference may be calculated based on the time at which the broadcast was received by UE1 902, as the subframe at which an SIB was broadcast can be determined by a UE. This logic is applicable to all examples of this disclosure where a particular time of broadcast or receipt is discussed.

In the example of FIG. 9, UE1 902 is not required to have actually received SIB-0 930, as UE1 902 is able to determine the subframe at which SIB-0 930 was broadcast, for example via an MIB broadcast (e.g. MIB 912) or via an SIB broadcast (e.g. SIB1-BR or SIB1-NB). UE1 902 then determines that a delay 951 between time T3 (at which UE1 902 receives SIB-0 940) and time T4 should be equal to the time difference 950. UE2 903 calculates time T4′ for uplink signal 923 through substantially similar methods. In particular, the delay 956 between time T3′ (at which UE2 903 receives SIB-0 940) is set to be equal to the time difference 955 between time TO′ (at which SIB-0 930 was either broadcast or received) and time T2′.

In this manner, the transmission of uplink signals 913, 923 may be spaced apart based, for example, on the time at which UEs 902, 903 prepared the uplink signals 913, 923 for transmission. Therefore, the natural, pseudo-random variation of when UEs 902, 903 prepare uplink signals 913, 923 for transmissions can be used to ensure the uplink transmissions 913, 923 are spaced to avoid clusters of uplink transmissions. Moreover, this approach prioritizes UEs that prepared the uplink signals at an earlier time. Therefore, no UE should have an undue delay between the time it prepared an uplink signal and the time at which the uplink signal is transmitted (e.g. the delay should be less than one SIB-0 period).

Alternatively, in some examples, a UE may transmit its uplink transmission at the time at which the contents of the uplink signal are stored in a buffer of the UE (i.e. when the contents of the uplink signal are prepared for transmission) if the UE already stores up to date satellite motion information. For example, UE1 902 may transmit its uplink signal at time T2 if UE1 902 has recently received satellite motion information via an SIB-0, for example SIB-0 930. Similarly, UE2 903 may transmit its uplink signal at time T2′ if it has recently received satellite motion information via an SIB-0, for example SIB-0 930. It is unlikely that time T2 equals T2′ as different UEs may have different data arrival times at their buffers and hence the UE uplink transmissions are naturally spread apart. A UE is deemed to have recent satellite information if, for example, it has last read SIB-0 within a pre-determined time T_{INFO}.

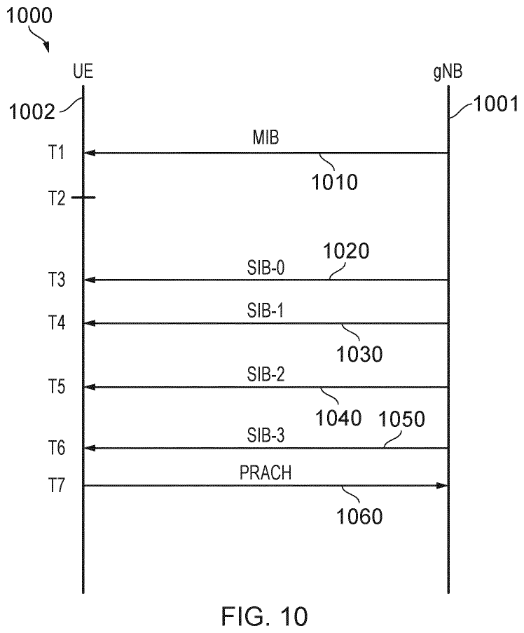

FIG. 10 shows an example arrangement 1000, where a UE 1002 determines when it is to transmit an uplink signal to gNB 1001. UE 1002 may receive signalling information at time T1, for example in MIB 1010 (such as MIB 810 or MIB 910), and may prepare an uplink signal for transmission at time T2. The UE 1002 then receives and reads SIB-0 1020 at time T3 and stores the satellite motion information provided by SIB-0 1030. Following receipt of SIB-0 1030, the UE 1002 receives and reads SIB broadcast SIB-1 1030 (no note that no technical significance should be attributed to the label ‘SIB-1’). SIB-1 1030 may be a number of different types of SIB broadcast that may contain signalling information (such as an SIB1-BR broadcast, or an SIB1-NB broadcast). UE 1002 may, for example, be provided with instructions to read SIB-1 1030 by an earlier MIB broadcast or by any other means, such as an earlier SIB broadcast.

SIB-1 1030 provides UE 1002 with an indication of whether UE 1002 is permitted to transmit its uplink signal. That is, SIB-1 1030 may define one or more criteria that set out whether a particular UE is permitted to access the network (e.g. by transmitting an uplink signal). These one or more criteria are based on UE-specific information. For example, the one or more criteria may be based on a UE_ID, such as those described above, or on an access class of the UE. In some examples, the UE-specific information may include the UE's uplink signal type (such as whether the UE wishes to transmit a PRACH, a PUCCH, or a PUSCH). SIB-1 1030 may for example define a time window in which UEs meeting the one or more criteria may access the network.

As just one example, SIB-1 1030 may indicate that UEs that have a UE_ID ending in one or more a particular values, such “0”, “1”, or “2” may access the network (e.g. in a specific time window). SIB-1 1030 may therefore indicate that all other UEs are not permitted to access the network. In the example of FIG. 10, the UE 1002 does not meet the one or more criteria set out in SIB-1 1030, therefore, the UE 1002 does not transmit the uplink signal 1060 in response to receiving SIB-1 1030. UE 1002 then receives and reads SIB-2 1040 at time T5 (note that no technical significance should be attributed to the label ‘SIB-2’ and SIB-2 1040 may be a different instance of the same SIB broadcast as SIB-1 1030). UE 1002 may, for example, be provided with instructions to read SIB-2 1040 by an MIB broadcast, by SIB-1 1030, or by any other means, such as an earlier SIB broadcast.

SIB-1 1030 provides UE 1002 with an indication of whether UE 1002 is permitted to transmit its uplink signal. That is, SIB-1 1030 may define one or more criteria that set out whether a particular UE is permitted to access the network (e.g. by transmitting an uplink signal). These one or more criteria are based on UE-specific information in the same way as SIB-1 1030. For example, SIB-2 1040 may indicate that UEs that have a UE_ID ending in “3”, “4”, or “5”, or that UEs having a UE_ID ending in any particular value (such as “5” or below) may access the network (e.g. in a specific time window). In the example of FIG. 10, the UE 1002 does not meet the one or more criteria set out in SIB-2 1040, therefore, SIB-2 1040 does not transmit the uplink signal 1060 in response to receiving SIB-2 1040. UE 1002 then receives and reads SIB-3 1050 at time T6 (note that no technical significance should be attributed to the label ‘SIB-3’ and SIB-3 1050 may be a different instance of the same SIB broadcast as SIB-1 1030 and SIB-2 1040). UE 1002 may, for example, be provided with instructions to read SIB-3 1050 by an MIB broadcast, by SIB-1 1030, by SIB-2 1040, or by any other means, such as an earlier SIB broadcast.

SIB-3 1050 provides UE 1002 with an indication of whether UE 1002 is permitted to transmit its uplink signal in a similar manner to SIB-1 1030 and SIB-2 1040. That is, SIB-3 1050 may define one or more criteria that set out whether a particular UE is permitted to access the network (e.g. by transmitting an uplink signal). are based on UE-specific information in the same way as SIB-1 1030 and SIB-2 1040. For example, SIB-3 1050 may indicate that UEs that have a UE_ID ending in “6”, or “7”, or that UEs having a UE_ID ending in any particular value (such as “7” or below) may access the network (e.g. in a specific time window). In the example of FIG. 10, the UE 1002 meets the one or more criteria set out by SIB-3 1050. Accordingly, after receiving (or storing) SIB-3 1050 at time T5, UE 1002 transmits its uplink signal 1060 at time T7. The uplink signal 1060 may be transmitted, for example, within a time period defined by SIB-3 1050, as early as possible after time T6, or at a time chosen by the UE 1002.

In this manner, the gNB 1001 or another entity that schedules SIB broadcasts, may assign times at which particular devices may access the network. As the scheduling of the access times for UEs is included within periodic SIB broadcasts, the gNB 1001 is given the flexibility to alter the one or more criteria for network access depending on any number of factors. For example, gNB 1001 may determine that an unexpectedly large number of uplink transmissions were initiated after SIB-1 1030, and therefore gNB 1001 may decide to adjust the one or more criteria for allowing access to the network in SIB-2 1040 in order to manage the number of UEs allowed These one or more criteria to access the network at a given time to reduce congestion.

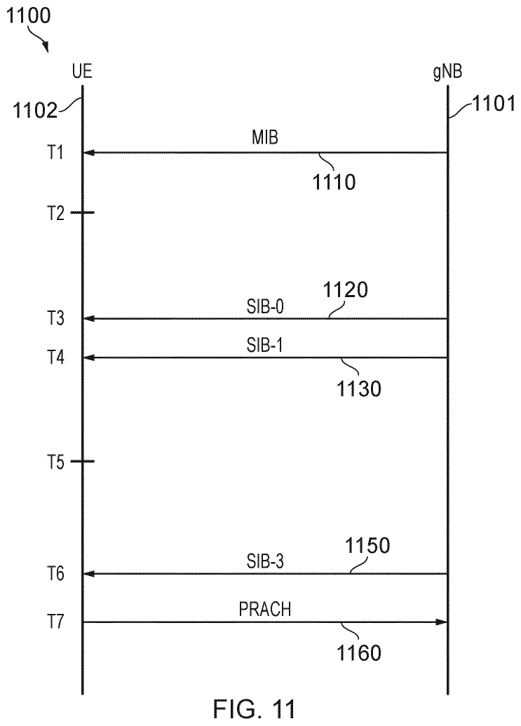

FIG. 11 shows an example arrangement 1100, where a UE 1102 determines when it is to transmit an uplink signal to gNB 1101. UE 1102 may receive signalling information at time T1, for example in MIB 1110, and prepares an uplink signal for transmission at time T2. The UE 1102 then receives and reads SIB-0 1120 at time T3 and stores the satellite motion information provided by SIB-0 1120. Following receipt of SIB-0 1120, the UE 1102 receives and reads SIB broadcast SIB-1 1130 (note that no technical significance should be attributed to the label ‘SIB-1’). SIB-1 1130 may be a number of different types of SIB broadcast that may contain signalling information (such as an SIB1-BR broadcast, or an SIB1-NB broadcast). UE 1102 may, for example, be provided with instructions to read SIB-1 1130 by an earlier MIB broadcast or by any other means, such as an earlier SIB broadcast.

SIB-1 1130 provides UE 1102 with an indication of whether UE 1102 is permitted to transmit its uplink signal. That is, SIB-1 1130 may define one or more criteria that set out whether a particular UE is permitted to access the network (e.g. by transmitting an uplink signal). These one or more criteria are based on UE-specific information. For example, the one or more criteria may be based on a UE_ID, such as those described above, or on an access class of the UE. In some examples, the UE-specific information may include the UE's uplink signal type (such as whether the UE wishes to transmit a PRACH, a PUCCH, or a PUSCH). SIB-1 1130 may for example define a time window in which UEs meeting the one or more criteria may access the network.

As just one example, SIB-1 1130 may indicate that UEs that have a UE_ID ending in one or more a particular values, such “0”, “1”, or “2” may access the network (e.g. in a specific time window). SIB-1 1030 may therefore indicate that all other UEs are not permitted to access the network. In the example of FIG. 11, the UE 1102 does not meet the one or more criteria set out in SIB-1 1130, therefore, SIB-1 1130 does not transmit the uplink signal 1160 in response to receiving SIB-1 1130. In the manner described above, the arrangement 1100 of FIG. 11 is similar to that of FIG. 10.

In the example of FIG. 11, SIB-1 1130 additionally indicates that UEs meeting one or more additional criteria will not be permitted access to the network until a time after the broadcast of SIB-3 1150 at time T6. For example, SIB-1 1130 may indicate that UEs that have a UE-ID ending in “7” will not be allowed access to the network until at least time T6 when SIB-3 is broadcast, or a time after time T6. Accordingly, if UE 1102 has a UE_ID ending in “7”, UE 1102 may determine that it meets these one or more additional criteria and therefore UE 1102 knows (for example by making a determination) that it will not be allowed access to the network until at least time T6 when SIB-3 1150 is broadcast. The UE 1102 may therefore ignore the SIB-2 broadcast shown in FIG. 10, which would have been broadcast at time T5. In this example, SIB-1 1130, SIB-2 (not shown) and SIB-3 1150 may be different instances of the same SIB broadcast.

In some examples, UE 1102 may, after receiving SIB-1 1130 alter its own power state in order to conserve power. For example, UE 1102 may enter a sleep mode (or low-power mode) until the time T6 when SIB-3 1150 is sent. The UE 1102 may determine to enter such a sleep mode based on its own settings, or UE 1102 may be instructed to enter a sleep mode by SIB-1 1130. As such, UE 1102 may conserve power by not listening for broadcasts which UE 1102 knows will not grant it access to the network.

At time T6, SIB-3 1150 is broadcast and the UE 1102 then receives and reads SIB-3 1150. SIB-3 1150 provides an indication of whether UE 1102 is permitted to transmit its uplink signal in the same manner as SIB-1 1130. For example, SIB-3 1150 indicates that UEs that have a UE-ID ending in “7” may access the network (e.g. in a specific time window). At this time, UE 1102 may perform an additional determination that UE 1102 meets the one or more criteria of SIB-3 1150. Accordingly, after determining that UE 1102 meets the one or more criteria of SIB-3 1150, UE 1102 transmits its uplink signal 1160 at time T7. In this manner, gNB 1101 is afforded the flexibility in scheduling provided by the arrangement of FIG. 10, while providing an arrangement that conserves UE power to the extent possible.

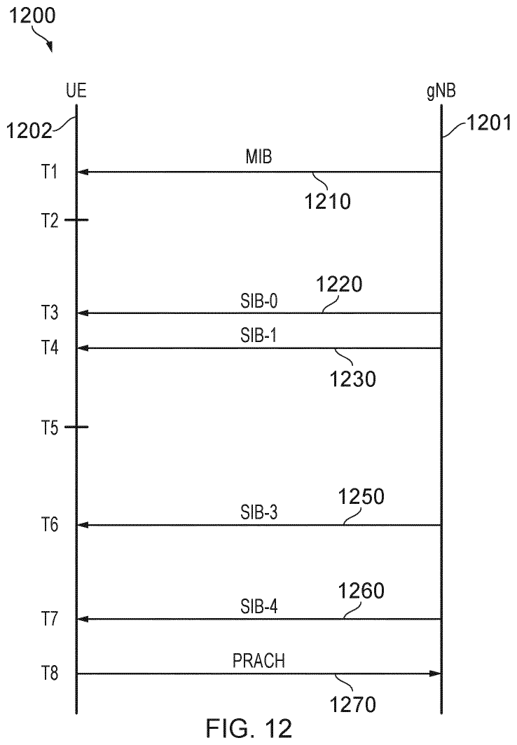

FIG. 12 shows an example arrangement 1200, where a UE 1202 determines when it is to transmit an uplink signal to gNB 1201. UE 1202 may receive signalling information at time T1, for example in MIB 1210, and prepares an uplink signal for transmission at time T2. The UE 1202 then receives and reads SIB-0 1220 at time T3 and stores the satellite motion information provided by SIB-0 1220. Following receipt of SIB-0 1220, the UE 1202 receives and reads SIB broadcast SIB-1 1230 (note that no technical significance should be attributed to the label ‘SIB-1’). SIB-1 1230 may be a number of different types of SIB broadcast that may contain signalling information (such as an SIB1-BR broadcast, or an SIB1-NB broadcast). UE 1202 may, for example, be provided with instructions to read SIB-1 1230 by an earlier MIB broadcast or by any other means, such as an earlier SIB broadcast.

SIB-1 1230 provides UE 1202 with an indication of whether UE 1202 is permitted to transmit its uplink signal. That is, SIB-1 1230 may define one or more criteria that set out whether a particular UE is permitted to access the network (e.g. by transmitting an uplink signal). These one or more criteria are based on UE-specific information. In the example of FIG. 12, the UE 1202 does not meet the one or more criteria set out in SIB-1 1230, therefore, UE 1202 does not transmit the uplink signal 1270 in response to receiving SIB-1 1230. Furthermore SIB-1 1230 additionally indicates that UEs meeting one or more additional criteria will not be permitted access to the network until at least a time of the broadcast (or after the broadcast) of SIB-3 1250 at time T6. UE 1202 meets these additional one or more criteria and therefore knows (for example by making a determination) that it will not be permitted access to the network until a time after the broadcast of SIB-3 1250 at time T6. UE 1202 therefore ignores the SIB-2 broadcast shown in FIG. 10, which would have been broadcast at time T5. In the manner described above, the arrangement of FIG. 12 is similar to that shown in FIG. 11.

At time T6, SIB-3 1250 is broadcast and the UE 1202 then receives and reads SIB-3 1250. SIB-3 1250 provides an indication of whether UE 1202 is permitted to transmit its uplink signal in the same manner as SIB-1 1230. In this example, the one or more criteria of SIB-3 1250 are such that particular UEs that SIB-1 1230 indicated would not be permitted to access the network until at least a time of the broadcast of SIB-3 1250 at time T6 are not permitted access to the network by SIB-3 1250. Accordingly, UE 1202 determines at (or just after) time T6 that it is not permitted to access the network and does not transmit its uplink signal 1270.

UE 1202 then receives and reads SIB-4 1260 that is broadcast at time T7. UE 1202 may be provided (for example by SIB-3 1250) with an indication that UEs fulfilling one or more criteria met by UE 1202 may not access the network until at least a time of the broadcast of SIB-4 1260. Alternatively, UE 1202 may be instructed to read SIB-4 1260 by SIB-3 1250, or UE 1202 may decide to read SIB-4 1260 based on the fact that UE 1202 does not meet the one or more criteria of SIB-3 1250. SIB-4 1260 provides an indication of whether UE 1202 is permitted to transmit its uplink signal in the same manner as SIB-1 1230 and SIB-3 1250. For example, SIB-4 1260 may indicate that UEs that have a UE-ID ending in “7” may access the network (e.g. in a specific time window). At this time, UE 1202 may perform an additional determination that UE 1202 meets the one or more criteria of SIB-4 1260. Accordingly, after determining that UE 1202 meets the one or more criteria of SIB-3 1260, UE 1202 transmits its uplink signal 1260 at time T8. In this manner, UE power may be conserved between SIB broadcasts that may be relevant, while providing additional flexibility for a gNB to alter the schedule for granting UEs access to the network. In this example, SIB-1 1230, SIB-2 (not shown), SIB-3 1250 and SIB-4 1260 may be different instances of the same SIB broadcast.

While the above examples describe the manner in which transmission of an uplink signal by a UE may be delayed beyond the time at which the UE receives up to date satellite motion information, in some examples the UE may already have up to date motion information. Therefore, the UE can transmit its uplink signal at the time when the UE has prepared the contents of the uplink signal for transmissions, rather than waiting until a subsequent SIB-0 broadcast, as described above. It may be determined that a UE has up to date satellite motion information if, for example, the UE has received satellite motion information within a pre-defined period of time. Therefore, the natural, pseudo-random variation of when UEs prepare uplink signals for transmission can be used to ensure the uplink transmissions are spaced to avoid clusters of uplink transmissions.

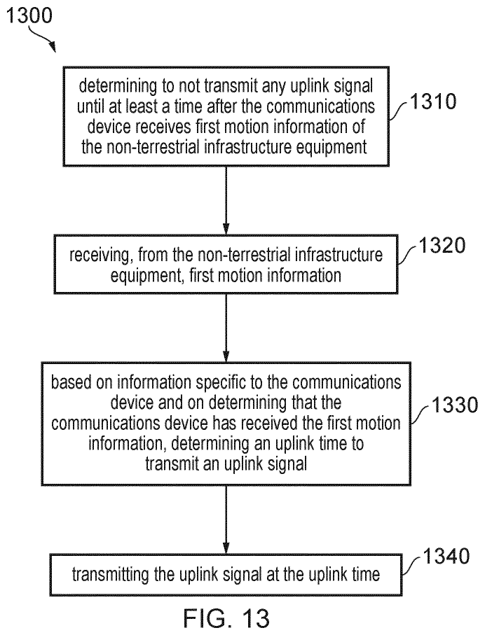

FIG. 13 shows a flow diagram of an example method 1300 of operating a communications device according to the present disclosure. The method includes a step 1310 determining to not transmit any uplink signal until at least a time after the communications device receives first motion information of the non-terrestrial infrastructure equipment. The method then includes a step 1320 of receiving, from the non-terrestrial infrastructure equipment, first motion information. The method also includes a step 1330 of based on information specific to the communications device and on determining that the communications device has received the first motion information, determining an uplink time to transmit an uplink signal. The method includes a further step 1340 of transmitting the uplink signal at the uplink time.

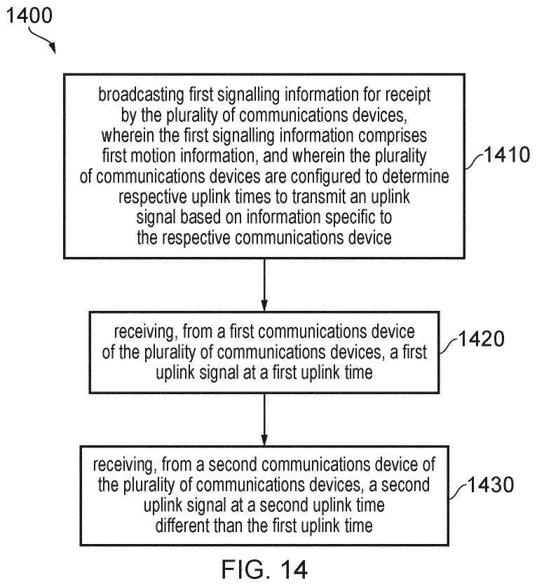

FIG. 14 shows a flow diagram of an example method 1400 of operating infrastructure equipment of an NTN according to the present disclosure. The method includes a step 1410 of broadcasting first signalling information for receipt by the plurality of communications devices, wherein the first signalling information comprises first motion information, and wherein the plurality of communications devices are configured to determine respective uplink times to transmit an uplink signal based on information specific to the respective communications device. The method also includes a step 1420 of receiving, from a first communications device of the plurality of communications devices, a first uplink signal at a first uplink time and a step 1430 of receiving, from a second communications device of the plurality of communications devices, a second uplink signal at a second uplink time different than the first uplink time.

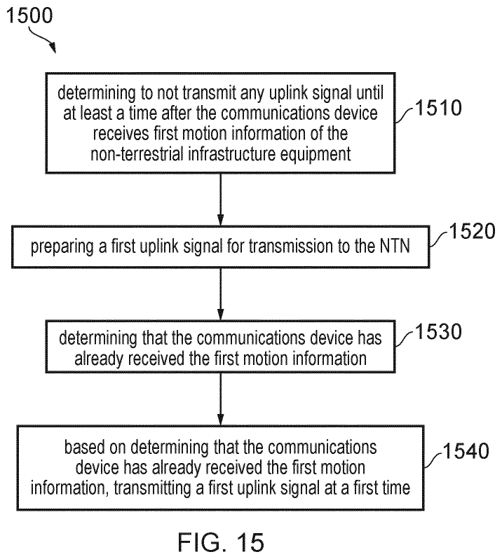

FIG. 15 shows a flow diagram of an example method 1500 of operating a communications device according to the present disclosure. The method 1500 includes a step 1510 of determining to not transmit any uplink signal until at least a time after the communications device receives first motion information of the non-terrestrial infrastructure equipment. The method also includes a step 1520 of preparing a first uplink signal for transmission to the NTN and a step 1530 of determining that the communications device has already received the first motion information. The method then includes a step 1540 of based on determining that the communications device has already received the first motion information, transmitting a first uplink signal at a first time.

In this manner, a communications device may make a determination not to transmit any uplink signal until at least a time after the communications device receives first motion information of the non-terrestrial infrastructure equipment. The communications device may then determine whether it has already received first motion information. If the communications device has already received the first motion information, the communications device transmits an uplink signal based on determining that it has already received the first motion information. The transmission of this uplink signal may occur prior to a next (or subsequent) broadcast of the first motion information by non-terrestrial infrastructure equipment.

Conversely, if the communications device has not already received the first motion information, the communications device does not transmit the uplink signal until after it has subsequently received the first motion information. After subsequently receiving the first motion information, the communications device then determines an uplink time to transmit the uplink signal based on information specific to the communications device and on determining that the communications device has received the first motion information. The communications device then transmits the uplink signal at the calculated uplink time.

These two possible approaches may be performed by the same communications device. For example, a communications device may perform the steps described above for when the communications device does not already store (or has not already received) up to date motion information, and then, after transmitting a first uplink signal, the communications device may, for a second uplink signal, determine that it has already received up to date motion information and may send the second uplink signal upon it being prepared (as described above). Similarly, a communications device may initially determine that it has already received up to date motion information and therefore transmit a first uplink signal, before preparing a second uplink signal for transmission and determining that it does not store up to date motion information (e.g. the motion information it stores is out of date). Accordingly, the communications device does not transmit the second uplink signal until after it has subsequently received up to date motion information.

Further examples of the present disclosure are set out in the following numbered clauses:

1. A method of operating a communications device configured to transmit uplink signals to and/or to receive downlink signals from a non-terrestrial infrastructure equipment forming part of a non-terrestrial network, NTN, the method comprising:
determining to not transmit any uplink signal until at least a time after the communications device receives first motion information of the non-terrestrial infrastructure equipment;
receiving, from the non-terrestrial infrastructure equipment, first motion information;
based on information specific to the communications device and on determining that the communications device has received the first motion information, determining an uplink time to transmit an uplink signal; and
transmitting the uplink signal at the uplink time.

2. The method of clause 1, wherein the determining is performed based on first signalling information received by the communication device at a first time.

3. The method of any preceding clause, wherein the information specific to the communications device is based on a unique identifier of the communications device.

4. The method of any preceding clause, wherein the first motion information is included within second signalling information, and wherein the second signalling information is received at a second time.

5. The method of any preceding clause, further comprising,
receiving third signalling information; and
determining that the third signalling information comprises an indication of whether the communications device is permitted to transmit the uplink signal to the NTN, based on the information specific to the communications device;
wherein the determination of the uplink time is additionally based on the indication included in the third signalling information; and
wherein the third signalling information is received at a third time.

6. The method of clause 5, wherein the indication included in the third signalling information comprises an indication that communications devices meeting one or more first criteria are permitted to transmit uplink signals after receipt of the third signalling information.

7. The method of clause 6, further comprising:
determining that the information specific to the communications device meets the one or more first criteria;
wherein determining the uplink time to transmit the uplink signal is additionally based on determining that the information specific to the communications device meets the one or more first criteria.

8. The method of clause 6, further comprising:
determining that the information specific to the communications device does not meet the one or more first criteria;
based on determining that the information specific to the communications device does not meet the one or more first criteria, determining not to transmit the uplink signal;
receiving, at a fourth time, fourth signalling information from the non-terrestrial infrastructure equipment, wherein the fourth time is after the third time;
determining that the fourth signalling information includes an indication that communications devices meeting one or more second criteria are permitted to transmit uplink signals after receipt of the fourth signalling information;
determining that the information specific to the communications device meets the one or more second criteria;
based on determining that the information specific to the communications device meets the one or more second criteria, determine the uplink time to transmit the uplink signal.

9. The method clause 8, further comprising:
determining that the third signalling information comprises a further indication that communications devices meeting one or more second criteria will not be permitted to transmit uplink signals until at least a fifth time at which fifth signalling information is scheduled to be receivable; and
determining that the information specific to the communications device meets the one or more second criteria.

10. The method of clause 9, further comprising:
altering a power state of the communications device until a predetermined interval before the fifth time.

11. The method of clause 9 or clause 10, wherein the fifth signalling information and the fourth signalling information are the same signalling information, and wherein the fifth time and the fourth time are the same time.

12. The method of clause 9 or clause 10, further comprising:
receiving the fifth signalling information at the fifth time, wherein the fifth time is earlier than the fourth time; and
determining that the fifth signalling information comprises an indication that communications devices meeting the one or more second criteria will not be permitted to transmit uplink signals until at least a fourth time at which fourth signalling information is scheduled to be receivable.

13. The method of any preceding clause, wherein the information specific to the communications device is based on an access class of the communications device.

14. The method of any preceding clause, further comprising:
generating one or more random numbers, wherein the information specific to the communications device comprises the one or more random numbers;
wherein determining the uplink time is additionally based on the one or more random numbers.

15. The method of clause 14, further comprising:
receiving an instruction to generate the one or more random numbers.

16. The method of any preceding clause, further comprising:
preparing an uplink signal for transmission to the NTN;
wherein the information specific to the communications device is based on a time at which the communications device prepared the uplink signal for transmission to the NTN.

17. The method of clause 16, wherein the information specific to the communications device is based on a time difference between a previous reception of first motion information of the non-terrestrial infrastructure equipment and the time at which the communications device prepared the uplink signal for transmission to the NTN.

18. The method of any preceding clause, wherein the first signalling information further comprises an indication for the communications device to determine a time for the communications device to transmit an uplink signal based on the information specific to the communications device.

19. A method of operating a communications device configured to transmit uplink signals to and/or to receive downlink signals from a non-terrestrial infrastructure equipment forming part of a non-terrestrial network, NTN, the method comprising:
determining to not transmit any uplink signal until at least a time after the communications device receives first motion information of the non-terrestrial infrastructure equipment;
preparing a first uplink signal for transmission to the NTN;
determining that the communications device has already received the first motion information;
based on determining that the communications device has already received the first motion information, transmitting a first uplink signal at a first time.

20. The method of clause 19, wherein determining that the communications device has already received the first motion information comprises determining that a time difference between a previous reception of first motion information of the non-terrestrial infrastructure equipment and a time at which the first uplink signal is prepared for transmission is less than a predetermined threshold.

21. The method of clause 19 or 20, further comprising:
receiving, at a second time, second motion information of the non-terrestrial infrastructure equipment, wherein the second time is after the first time.

22. A communications device comprising:
a transceiver configured to transmit uplink signals to and/or to receive downlink signals from a non-terrestrial infrastructure equipment forming part of a non-terrestrial network, NTN; and
a controller configured in combination with the transceiver to
   determine to not transmit any uplink signal until at least a time after the communications device receives first motion information of the non-terrestrial infrastructure equipment;
   receive, from the non-terrestrial infrastructure equipment, the first motion information;
   based on information specific to the communications device and on determining that the communications device has received the first motion information, determine an uplink time to transmit an uplink signal; and
   transmit the uplink signal at the uplink time.

23. A communications device comprising:
a transceiver configured to transmit uplink signals to and/or to receive downlink signals from a non-terrestrial infrastructure equipment forming part of a non-terrestrial network, NTN; and
a controller configured in combination with the transceiver to
   determine to not transmit any uplink signal until at least a time after the communications device receives first motion information of the non-terrestrial infrastructure equipment;
   prepare a first uplink signal for transmission to the NTN;
   determine that the communications device has already received the first motion information;
   based on determining that the communications device has already received the first motion information, transmit a first uplink signal at a first time.

24. Circuitry for a communications device, the circuitry comprising:
transceiver circuitry configured to transmit uplink signals to and/or to receive downlink signals from a non-terrestrial infrastructure equipment forming part of a non-terrestrial network, NTN; and
controller circuitry configured in combination with the transceiver to
   determine to not transmit any uplink signal until at least a time after the communications device receives first motion information of the non-terrestrial infrastructure equipment;
   receive, from the non-terrestrial infrastructure equipment, the first motion information;
   based on information specific to the communications device and on determining that the communications device has received the first motion information, determine an uplink time to transmit an uplink signal; and
   transmit the uplink signal at the uplink time.

25. Circuitry for a communications device, the circuitry comprising:
transceiver circuitry configured to transmit uplink signals to and/or to receive downlink signals from a non-terrestrial infrastructure equipment forming part of a non-terrestrial network, NTN; and
controller circuitry configured in combination with the transceiver to
   determine to not transmit any uplink signal until at least a time after the communications device receives first motion information of the non-terrestrial infrastructure equipment;
   prepare a first uplink signal for transmission to the NTN;
   determine that the communications device has already received the first motion information;
   based on determining that the communications device has already received the first motion information, transmit a first uplink signal at a first time.

26. A method of operating infrastructure equipment forming part of a non-terrestrial network, NTN, the method comprising:
broadcasting first signalling information for receipt by the plurality of communications devices, wherein the first signalling information comprises first motion information, and wherein the plurality of communications devices are configured to determine respective uplink times to transmit an uplink signal based on information specific to the respective communications device;
receiving, from a first communications device of the plurality of communications devices, a first uplink signal at a first uplink time; and
receiving, from a second communications device of the plurality of communications devices, a second uplink signal at a second uplink time different than the first uplink time.

27. The method of clause 26, further comprising:
transmitting second signalling information for receipt by the plurality of communications devices, wherein the second signalling information comprises first instructions that instruct each communications device of the plurality of communications devices not to transmit any uplink signal until at least a time after the each communications device has received first motion information of non-terrestrial infrastructure equipment of the non-terrestrial network,
wherein the second signalling information further comprises an indication for each communications device to determine a time for the each communications device to transmit an uplink signal based on information specific to the each communications device.

28. The method of clause 26 or clause 27, further comprising:
broadcasting third signalling information for receipt by the plurality of communications devices, wherein the third signalling information comprises an indication that communications devices meeting one or more first criteria are permitted to transmit uplink signals after receipt of the third signalling information,
wherein the first signalling information is broadcast at a first time, wherein the second signalling information is transmitted at a second time, and wherein the third signalling information is broadcast at a third time.

29. The method of clause 28, further comprising:
broadcasting, at a fourth time, fourth signalling information for receipt by the plurality of communications devices, wherein the fourth signalling information comprises an indication that communications devices meeting one or more second criteria are permitted to transmit uplink signals after receipt of the fourth signalling information.

30. The method of clause 29, wherein the third signalling information comprises a further indication that communications devices meeting one or more second criteria will not be permitted to transmit uplink signals until at least a fifth time at which fifth signalling information is scheduled to be broadcast; and
wherein the method further comprises broadcasting the fifth signalling information at the fifth time.

31. The method of clause 30, wherein the fifth signalling information and the fourth signalling information are the same signalling information, and wherein the fifth time and the fourth time are the same time.

32. The method of clause 30, further comprising:
broadcasting the fifth signalling information at the fifth time, wherein the fifth time is earlier than the fourth time;
wherein the fifth signalling information comprises an indication that communications devices meeting one or more second criteria will not be permitted to transmit uplink signals until at least a fourth time at which fourth signalling information is scheduled to be broadcast.

33. The method of any of clauses 27-32, wherein the second signalling information is broadcast for receipt by the plurality of communications devices.

34. The method of any of clauses 26-33, wherein the first uplink time is prior to the broadcasting of the first signalling information.

35. Infrastructure equipment for use in a non-terrestrial network, NTN, wherein the infrastructure equipment comprises:
a transceiver configured to transmit downlink signals to and/or receive uplink signals from one or more communications devices; and
a controller configured in combination with the transceiver to
   broadcast first signalling information for receipt by a plurality of communications devices, wherein the first signalling information comprises first motion information, and wherein the plurality of communications devices are configured to determine respective uplink times to transmit an uplink signal based on information specific to the respective communications device; receive, from a first communications device of the plurality of communications devices, a first uplink signal at a first uplink time; and
   receive, from a second communications device of the plurality of communications devices, a second uplink signal at a second uplink time different than the first uplink time.

36. Circuity for infrastructure equipment for use in a non-terrestrial network, NTN, the circuitry comprising:
transceiver circuitry configured to transmit downlink signals to and/or receive uplink signals from one or more communications devices; and
controller circuitry configured in combination with the transceiver circuitry to
   broadcast first signalling information for receipt by a plurality of communications devices, wherein the first signalling information comprises first motion information, and wherein the plurality of communications devices are configured to determine respective uplink times to transmit an uplink signal based on information specific to the respective communications device; receive, from a first communications device of the plurality of communications devices, a first uplink signal at a first uplink time; and
   receive, from a second communications device of the plurality of communications devices, a second uplink signal at a second uplink time different than the first uplink time.

37. A system comprising:
a communications device according to clause 22 and/or 23; and
an infrastructure equipment according to clause 35.

37. A method of operating a non-terrestrial network, NTN, the method comprising:
a method of operating a communications device according to any of clauses 1-21; and
a method of operating infrastructure equipment according to any of clauses 26-34.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] TR 38.811, “Study on New Radio (NR) to support non terrestrial networks (Release 15)”, 3rd Generation Partnership Project, December 2017.
[2] Holma H. and Toskala A, “LTE for UMTS OFDMA and SC-FDMA based radio access”, John Wiley and Sons, 2009.

1. A method of operating a communications device configured to transmit uplink signals to and/or to receive downlink signals from a non-terrestrial infrastructure equipment forming part of a non-terrestrial network, NTN, the method comprising:
determining to not transmit any uplink signal until at least a time after the communications device receives first motion information of the non-terrestrial infrastructure equipment;
receiving, from the non-terrestrial infrastructure equipment, first motion information;
based on information specific to the communications device and on determining that the communications device has received the first motion information, determining an uplink time to transmit an uplink signal; and
transmitting the uplink signal at the uplink time.

2. The method of claim 1, wherein the determining is performed based on first signalling information received by the communication device at a first time

3. The method of claim 1, wherein the information specific to the communications device is based on a unique identifier of the communications device.

4. The method of claim 1, wherein the first motion information is included within second signalling information, and wherein the second signalling information is received at a second time.

5. The method of claim 1, further comprising,
receiving third signalling information; and
determining that the third signalling information comprises an indication of whether the communications device is permitted to transmit the uplink signal to the NTN, based on the information specific to the communications device;
wherein the determination of the uplink time is additionally based on the indication included in the third signalling information; and
wherein the third signalling information is received at a third time.

6. The method of claim 5, wherein the indication included in the third signalling information comprises an indication that communications devices meeting one or more first criteria are permitted to transmit uplink signals after receipt of the third signalling information.

7. The method of claim 6, further comprising:
determining that the information specific to the communications device meets the one or more first criteria;
wherein determining the uplink time to transmit the uplink signal is additionally based on determining that the information specific to the communications device meets the one or more first criteria.

8. The method of claim 6, further comprising:
determining that the information specific to the communications device does not meet the one or more first criteria;
based on determining that the information specific to the communications device does not meet the one or more first criteria, determining not to transmit the uplink signal;
receiving, at a fourth time, fourth signalling information from the non-terrestrial infrastructure equipment, wherein the fourth time is after the third time;
determining that the fourth signalling information includes an indication that communications devices meeting one or more second criteria are permitted to transmit uplink signals after receipt of the fourth signalling information;
determining that the information specific to the communications device meets the one or more second criteria;
based on determining that the information specific to the communications device meets the one or more second criteria, determine the uplink time to transmit the uplink signal.

9. The method claim 8, further comprising:
determining that the third signalling information comprises a further indication that communications devices meeting one or more second criteria will not be permitted to transmit uplink signals until at least a fifth time at which fifth signalling information is scheduled to be receivable; and
determining that the information specific to the communications device meets the one or more second criteria.

10. The method of claim 9, further comprising:
altering a power state of the communications device until a predetermined interval before the fifth time.

11. The method of claim 9, wherein the fifth signalling information and the fourth signalling information are the same signalling information, and wherein the fifth time and the fourth time are the same time.

12. The method of claim 9, further comprising:
receiving the fifth signalling information at the fifth time, wherein the fifth time is earlier than the fourth time; and
determining that the fifth signalling information comprises an indication that communications devices meeting the one or more second criteria will not be permitted to transmit uplink signals until at least a fourth time at which fourth signalling information is scheduled to be receivable.

13. The method of claim 1, wherein the information specific to the communications device is based on an access class of the communications device.

14. The method of claim 1, further comprising:
generating one or more random numbers, wherein the information specific to the communications device comprises the one or more random numbers;
wherein determining the uplink time is additionally based on the one or more random numbers.

15. The method of claim 1, further comprising:
preparing an uplink signal for transmission to the NTN;
wherein the information specific to the communications device is based on a time at which the communications device prepared the uplink signal for transmission to the NTN.

16. A method of operating a communications device configured to transmit uplink signals to and/or to receive downlink signals from a non-terrestrial infrastructure equipment forming part of a non-terrestrial network, NTN, the method comprising:
determining to not transmit any uplink signal until at least a time after the communications device receives first motion information of the non-terrestrial infrastructure equipment;
preparing a first uplink signal for transmission to the NTN;
determining that the communications device has already received the first motion information;
based on determining that the communications device has already received the first motion information, transmitting a first uplink signal at a first time.

17. The method of claim 16, wherein determining that the communications device has already received the first motion information comprises determining that a time difference between a previous reception of motion information of the non-terrestrial infrastructure equipment and a time at which the first uplink signal is prepared for transmissions is less than a predetermined threshold.

18. The method of claim 16, further comprising:
receiving, at a second time, second motion information of the non-terrestrial infrastructure equipment, wherein the second time is after the first time.

19. A communications device comprising:
a transceiver configured to transmit uplink signals to and/or to receive downlink signals from a non-terrestrial infrastructure equipment forming part of a non-terrestrial network, NTN; and
a controller configured in combination with the transceiver to
determine to not transmit any uplink signal until at least a time after the communications device receives first motion information of the non-terrestrial infrastructure equipment;
receive, from the non-terrestrial infrastructure equipment, the first motion information;
based on information specific to the communications device and on determining that the communications device has received the first motion information, determine an uplink time to transmit an uplink signal; and
transmit the uplink signal at the uplink time.

20.-27. (canceled)
